(19) United States
(12) Patent Application Publication
(10) Pub. No.: US 2005/0178787 A1
(43) Pub. Date: Aug. 18, 2005

(54) Display device

(76) Inventors: Glenn Carlin, Kent, CT (US); Gilbert Aviles, Accord, NY (US)

Correspondence Address: McCormick, Paulding & Huber LLP, 185 Asylum Street, CityPlace II, Hartford, CT, 06103-3402, US

(21) Appl. No.: 10/729,445

(22) Filed: Dec. 5, 2003

(51) Int. Cl. B23Q 7/12; B65H 9/00

(52) U.S. Cl. 221/156

(57) ABSTRACT

A display device disposes in an upside down orientation at least one container having a body portion and a neck portion wherein the neck portion is disposed below the body portion when the product is in the upside down orientation. The display device is useful for articles having labels which convey meaning in an upright and upside down orientation. The display device includes an elongated member defining a conduit extending between first and second ends for accommodating one or more containers in an upside down orientation such that the neck portion of the containers face the second end of the conduit. A stop member is associated with the elongated member and disposed beyond the conduit and adjacent to the second end for providing a barrier to thereby prevent containers from falling out of or otherwise accidentally leaving the conduit.

### FIELD OF THE INVENTION

This invention relates generally to display devices, and more particularly to beverage display and dispenser devices.

### BACKGROUND OF THE INVENTION

Consumer products for sale are typically displayed and dispensed in an upright orientation determined by conventional or standard practice in the industry associated with the products. Product labels on the consumer products are typically intended to be read or otherwise convey meaning when the labeled products are in the conventionally understood upright orientation. For example, the label is placed on the bottle in order to be read or convey meaning with the neck portion disposed above the body portion because the upright orientation of a beverage bottle is conventionally with the neck portion of the bottle disposed above the body portion thereof.

At least one product manufacturer has developed a product name and label which conveys meaning when viewed on its product in a conventional upright orientation and in a conventional upside down orientation. For example, the beverage manufacturer Dr. Pepper/Seven Up, Inc. has recently introduced a beverage dnL™ which is a play on words of its well-established beverage 7up®. More specifically, the beverage label having the designation “dnL” when turned upside down designates “7up”. This association or identity of the manufacturer of dnL™ with that of 7up® may be subtle and thereby not noticed by potential consumers. In order to provide such consumers with an opportunity for associating the manufacturer of the product dnL™ with that of 7up®, it would be advantageous to have a display adapted for showing and/or dispensing such beverage bottles in an upsidedown orientation whereby the designation of 7up® is conveyed to the potential consumers. Moreover, a designation conveying meaning when the such product is in an upside down orientation will tend to arouse the curiosity of consumers as to what the designation conveys for the product when in the upright orientation.

In view of the foregoing, it is an object of the present invention to provide a product display and/or dispenser which disposes products in an upside down orientation where such products have labels conveying meaning in both upright and upside down orientations.

### SUMMARY OF THE INVENTION

The present invention resides in a display device for disposing in an upside down orientation at least one container having a body portion and a neck portion wherein the neck portion is disposed below the body portion when the product is in the upside down orientation. The display device is useful for products having labels which convey meaning in an upright orientation and an upside down orientation. The display device includes an elongated member defining a conduit extending between first and second ends for accommodating at least one container in an upside down orientation such that the neck portion of the at least one container faces the second end of the conduit. A stop member is associated with the elongated member and disposed beyond the conduit and adjacent to the second end for providing a barrier to thereby prevent a bottommost container from accidentally leaving the conduit. Preferably, the stop member includes a projection defining an opening for accommodating and securing therein the neck portion of a bottommost container. More preferably, the opening is open-ended for permitting the neck portion of a container accommodated therein to be grasped and pivoted out of the opening in order to dispense the container from the conduit.

### BRIEF DESCRIPTION OF THE DRAWINGS

FIG. 1 is perspective view of a display device embodying the present invention mounted on an external surface.

FIG. 2 is a perspective view of the display device of FIG. 1 partially filled with beverage bottles.

FIG. 3 is a perspective view of a stop member of the display device of FIG. 1.

FIG. 4 is a perspective view of the display device of FIG. 1 in a folded condition.

FIG. 5 is a perspective view of the display device of FIG. 1 in a partially unfolded condition.

### DETAILED DESCRIPTION OF THE PREFERRED EMBODIMENT

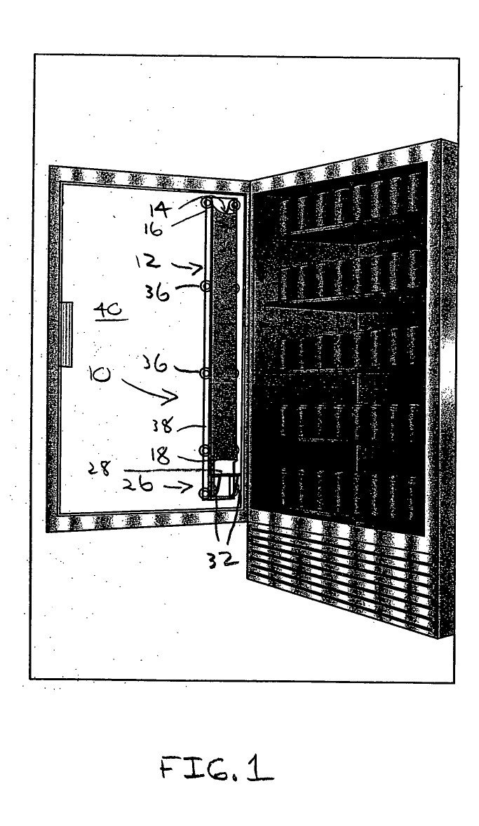

With reference to FIGS. 1-3, a display device embodying the present invention is designated generally by the reference number 10. The display device 10 includes an elongated member 12 defining a conduit 14 extending generally along an axial direction A from a first end 16 to a second end 18 for accommodating and dispensing therefrom at least one container 20 having a body portion 22 and a neck portion 24 such as, for example, a 20 oz. beverage bottle. More specifically, the elongated member 12 at the first end 16 defines a conduit opening for permitting the at least one container 20 to be loaded into the conduit 14. Similarly, the elongated member 12 at the second end 18 defines another conduit opening for permitting the at least one container 20 to be dispensed from the conduit 14.

As will be explained more fully below, the at least one container 20 is operationally disposed in the conduit 14 of the display device 10 in an upside down orientation such that the neck portion 24 of the container generally faces the second end 18 of the conduit. The conduit 14 is preferably sized to accommodate five, 20 oz. containers in end-to-end fashion, but can be sized to accommodate a fewer or greater number of containers without departing from the scope of the present invention.

The display device 10 is especially useful in displaying and dispensing containers 20 carrying product information which conveys meaning both when the container is in an upright orientation and when in an upside down orientation. For example, the beverage dnL™, manufactured by Dr. Pepper/Seven Up. Inc., as conveyed on the product when the product is in an upright orientation, also conveys “7up” when in an upside down orientation to thereby inform potential consumers of the manufacturer of the beverage dnL™.

The display device 10 preferably includes a stop member 26 coupled to the elongated member 12 and disposed adjacent to the second end 18 and beyond the conduit 14. The stop member 26 provides a barrier such that a container 20 disposed at the second end 18 of the conduit 14 is prevented from accidentally falling out of or otherwise leaving the conduit. The stop member 26 is preferably spaced from the second end 18 of the conduit 14 such that a portion of a container 20 disposed at the second end is exposed between the second end and the stop member for grasping and removal from the conduit.

More specifically, the stop member 26 preferably includes a projection 28 coupled to and extending outwardly in a direction generally perpendicular to that of the axial direction A of the conduit 14 so as to form a ledge to abut with the neck portion 24 of a container 20 disposed at the second end 18 to thereby prevent the container at the second end from accidentally falling out of or otherwise leaving the conduit. Preferably, the stop member 26 includes brace members or brackets 32, 32 disposed below and on each side of the projection 28 to reinforce the projection.

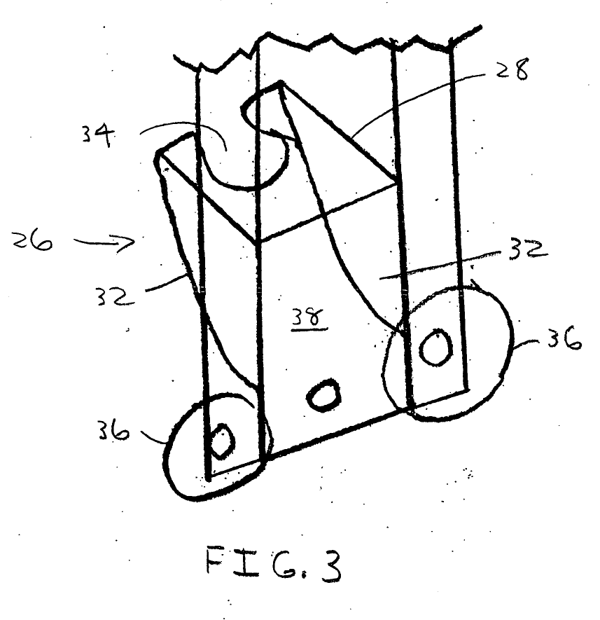

As best shown in FIG. 3, the projection 28 can define an opening 34 sized for accommodating and securing therein the neck portion 24 of a container 20 to further ensure that the container is prevented from accidentally falling out of the conduit 14. The opening 34 defined by the projection 28 can be open-ended as shown in FIG. 3 to enable the neck portion 24 of the container 20 to be grasped, lifted and pivoted out of the opening in a direction toward the open end in order to dispense the container from the conduit 14 as will be explained more fully below.

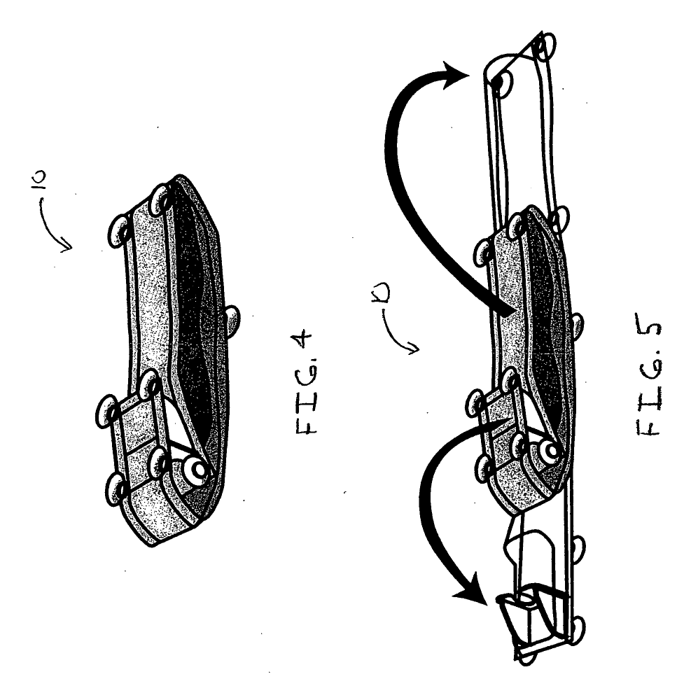

Preferably, at least a portion of the elongated member 12 defining the conduit 14 is made of a flexible material such as, for example, plastic, to permit the elongated member to be folded into two or more sections when not in use. For example, FIG. 4 illustrates the display device 10 in a folded condition, and FIG. 5 illustrates the display device in a partially unfolded condition. Moreover, the portion of the elongated member 12 defining the conduit 14 is preferably generally cylindrical so as to flexibly conform to the shape of generally cylindrical containers 20 disposed in the conduit. At least a portion of the elongated member 12 defining the conduit 14 is generally transparent to display and advertise the containers 20 disposed in the conduit.

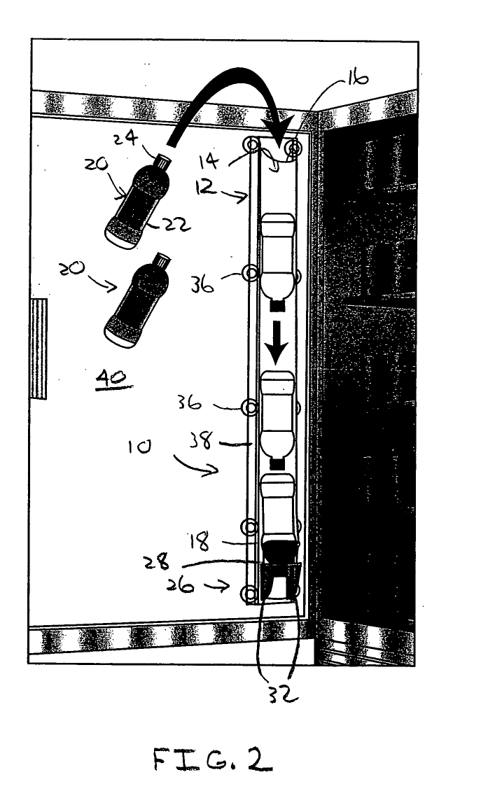

The display device 10 may include at least one fastener for attaching the display device to an external mounting surface such as the indoor surface of a cooler door. As shown in FIGS. 1 and 2, the fastener can include a plurality of suction cups 36, 36 attached to a substantially flat back surface 38 of the elongated member 12. However, other types of fasteners, such as adhesive strips, may be substituted without departing from the scope of the present invention.

In operation, the display device 10 is unfolded and mounted to a generally vertical surface 40. For example, the display device 10 can be mounted to the inside of a transparent door of a beverage cooler vault, preferably as dose as possible to the inside hinge of the door away from the handle of the door in order to maintain bottled product temperature and to lessen torque exerted on the door hinges. The display device 10 should be mounted to the vertical surface 40 such that the axial length A of the conduit 14 extends in a vertical direction and wherein the first end 16 of the conduit 14 is disposed above the second end 18.

A plurality of containers 20, 20 are inserted in upside down orientation into the conduit 14. For example, a first container 20 is loaded neck portion first through the conduit opening at the first end 16 into the conduit 14. The first container 20 preferably gravitationally slides downwardly through the conduit 14 until the neck portion 24 abuts against the stop member 26 and is thereby prevented from accidentally falling out of or otherwise leaving the conduit. More specifically, the neck portion 24 of the first container 20 is accommodated by and thereby secured in position within the opening 34 defined by the projection 28 of the stop member 26. A second container 20 can be then loaded neck portion first through the conduit opening at the first end 16 into the conduit 14. The second container 20 gravitationally slides downwardly through the conduit 14 until the neck portion 24 of the second container abuts the body portion 22 of the first container 20. A third container 20 can be then loaded neck portion first through the conduit opening at the first end 16 into the conduit 14. The third container 20 gravitationally slides downwardly through the conduit 14 until the neck portion 24 of the third container abuts the body portion 22 of the second container 20. This process can be repeated until the conduit 14 is substantially filled from the first end 16 to the second end 18 with containers 20, 20 positioned in end-to-end fashion.

The first or bottommost container 20 adjacent to the second end 18 of the conduit 14 has a body portion 22 generally disposed within the conduit, and a neck portion 24 exposed beyond the second end of the conduit. The neck portion 24 of the bottommost container 20 can be grasped and lifted slightly upwardly and pivoted outwardly out of the open end of the opening 34 defined by the projection 28 of the stop member 26 in order to dispense the container from the display device 10. The remaining containers 20, 20 disposed within the conduit 14 then gravitationally slide downwardly until the now bottommost container 20 is prevented by the stop member 26 from moving further downward and otherwise leaving the conduit. The process of dispensing the bottommost container 20 from the conduit 14 can be repeated until all of the containers 20, 20 disposed within the conduit are dispensed therefrom. However, it is preferable that the conduit 14 is periodically loaded with containers 20, 20 so that the display device 10 never becomes empty.

As will be recognized by those of ordinary skill in the pertinent art, numerous modifications and substitutions may be made to the above-described embodiment of the present invention without departing from the scope of the invention as set forth in the appended claims. Accordingly, the preceding portion of this specification is to be taken in an illustrative, as opposed to a limiting sense.

1. A display device for disposing in an upside down orientation at least one container having a body portion and a neck portion wherein the neck portion is disposed below the body portion when the product is in the upside down orientation, the display device comprising:
an elongated member defining a conduit extending between first and second ends for accommodating at least one container in an upside down orientation such that the neck portion of the at least one container faces the second end of the conduit; and
a stop member associated with the elongated member and disposed beyond the conduit and adjacent to the second end for providing a barrier to thereby prevent a container from accidentally leaving the conduit.

2. A display device as defined in claim 1, wherein the stop member is spaced from the second end such that a portion of a container disposed at the second end is exposed between the second end and the stop member for grasping and being dispensed from the conduit.

3. A display device as defined in claim 1, wherein the stop member includes a projection coupled to the elongated member.

4. A display device as defined in claim 3, wherein the projection defines an opening for accommodating the neck portion of a container.

5. A display device as defined in claim 4, wherein the opening is open-ended for permitting the neck portion of a container accommodated therein to be pivoted out of the opening in order to dispense the container from the conduit.

6. A display device as defined in claim 3, wherein the stop member further includes at least one brace member coupled to the projection and the elongated member.

7. A display device as defined in claim 3, wherein the stop member further includes two brace members coupled to sides of the projection and to the elongated member.

8. A display device as defined in claim 1, wherein the conduit defined by the elongated member is generally cylindrical.

9. A display device as defined in claim 1, wherein the elongated member is generally transparent.

10. A display device as defined in claim 1, wherein a portion of the elongated member defining the conduit is made from a flexible material for permitting folding of the elongated member when not in use.

11. A display device as defined in claim 1, wherein the flexible material includes plastic.

12. A display device as defined in claim 1, further including at least one fastener for attaching the elongated member to an external mounting surface.

13. A display device as defined in claim 12, wherein the at least one fastener is a suction cup.

14. A display device as defined in claim 1, wherein the conduit defined by the elongated member is sized to accommodate a 20 oz. beverage bottle.

15. A display device as defined in claim 1, wherein the conduit defined by the elongated member is sized to accommodate five 20-oz beverage bottles in end-to-end fashion.

16. A display device as defined in claim 1, wherein the elongated member at the first end defines a conduit opening for permitting the at least one container to be loaded into the conduit.

17. A display device as defined in claim 1, wherein the elongated member at the second end defines a conduit opening for permitting the at least one container to be dispensed from the conduit.
